(19) United States
(12) Patent Application Publication
(10) Pub. No.: US 2004/0256322 A1
(43) Pub. Date: Dec. 23, 2004

(54) Method for preventing scaling of membranes in a one-step membrane process

(76) Inventor: Marco Johannes Wilhelmus Frank, Groenlo (NL)

Correspondence Address: OLIFF & BERRIDGE, PLC, P.O. BOX 19928, ALEXANDRIA, VA, 22320, US

(21) Appl. No.: 10/491,085

(22) PCT Filed: Sep. 27, 2002
(86) PCT No.: PCT/EP02/11071

(30) Foreign Application Priority Data
Oct. 3, 2001 (EP) 01203739.6

(51) Int. Cl. B01D 61/00

(52) U.S. Cl. 210/651; 210/650; 210/696

(57) ABSTRACT

The invention pertains to a method for preventing scaling of ultrafiltration or nanofiltration membranes in a one-step membrane process of separating an organic compound or a biomass and a soluble inorganic salt from an aqueous feed mixture, which mixture further comprises one or more inorganic compounds, that cause scaling, such as calcium carbonate, calcium sulfate, calcium sulfite, magnesium sulfate, calcium oxalate and silica, by using an ultrafiltration or nanofiltration membrane, characterized in that the feed mixture is diluted with an amount of water which is at least equal to the amount of water that is removed by the membrane from the feed mixture minus the amount of water that can be removed without precipitation of the inorganic compounds in the feed mixture.

The invention pertains to a method for preventing scaling of ultrafiltration or nanofiltration membranes in a one-step membrane process of separating an organic compound or a biomass and a soluble inorganic salt from an aqueous feed mixture, which mixture further comprises one or more inorganic compounds, that cause scaling, by using an ultrafiltration or nanofiltration membrane.

Membrane filtration processes, such as ultrafiltration (UF) and nanofiltration (NF) membrane processes are known in the art and effective for separation of organic molecules and monovalent ions. For instance, J. Schaep et al., Separation and Purification Technology, 14 (1998), 155-162, studied NF membranes and found low retentions for chloride ions (magnesium and sodium chloride), contrary to the much higher retentions of divalent anions. The low retention of halogenide ions makes it e.g. possible to separate halogenide ions from organic molecules. However, although the separation process can be performed efficiently as such, the separation of organic molecules and monovalent ions runs into problems when the feed comprises insoluble compounds, because of scaling of the membrane. Thus the use of UF or NF membranes in such separation processes is limited due to the tendency of precipitation and/or scaling of compounds such as calcium carbonate, calcium sulfate, calcium sulfite, magnesium sulfate, calcium oxalate and silica. Standard solutions of preventing scaling are disclosed in for instance the Membrane Handbook (edited by Ho and Sirkar, 1992) and Water Treatment Membrane Processes (edited by Mallevialle et al., 1996) and include the addition of auxiliary compounds such as acids, water softening agents, complexing agents or anti-scaling agents. These standard methods are often insufficient to fully prevent scaling. This problem is addressed in U.S. Pat. No. 6,113,797 and it was found that this process could be improved by providing a two-stage membrane process in which the bulk of the water is purified by the first membrane stage at low pressure, after which the concentrate is further purified in a second membrane process at high pressure. According to this process it is necessary to add softening agents during the second membrane process to prevent scaling. Such process has a few disadvantages. First, a two-step process is more complicated than a one-step procedure and thus economically less preferred, whereas the addition of a softening agent further increases the purification costs, and moreover can lead to additional purification problems when the softening agent should be removed. Therefore, it is preferred to use a one-step procedure without the need to add softening agents. The method of the invention has the advantage that the addition of an acid, anti-scaling agent or softening agent is not longer required, and the method of the invention is therefore preferably performed without such addition.

The present invention provides a solution for the above-mentioned problems in that a method is found for preventing scaling of ultrafiltration or nanofiltration membranes in the above-mentioned one-step membrane process of separating an aqueous feed mixture of an organic compound or a biomass and an inorganic salt in the presence of inorganic compounds, that cause scaling, characterized in that the feed mixture is diluted with an amount of water which is at least equal to the amount of water that is removed by the membrane from the feed mixture minus the amount of water that can be removed without precipitation of the inorganic compounds in the feed mixture.

The feed mixture may comprise inorganic compounds, that cause scaling, selected from calcium carbonate, calcium sulfate, calcium sulfite, magnesium sulfate, calcium oxalate and silica. Preferably, the feed mixture comprises at least one of calcium sulfate and calcium sulfite.

The method of the invention is particularly useful when the inorganic salt is a salt of a monovalent inorganic anion and a mono- or polyvalent cation, such as a sodium, potassium, magnesium, or calcium ion. The monovalent anion is preferably a halogenide ion, such as chloride.

The method is further very suitable for the separation of chelating agents, preferably an amino polycarboxylic acid such as EDTA (ethylenediaminetetraacetic acid) or a metal complex thereof, from inorganic salts.

Since it is known that calcium sulfate causes lot of scaling, the method is particularly suitable when the feed mixture comprises calcium sulfate. In U.S. Pat. No. 5,766,478 a diafiltration technique is disclosed for maintaining a high removal rate of the compound to be removed. This method, however, is not used to prevent scaling. The inorganic compounds in the feed mixture are generally saturated, supersaturated or non-dissolved. The method of the invention is also suitable for a non-saturated feed mixture which becomes saturated due to the addition of a concentrated solution, for instance a recycled concentrate, or due to any other process that leads to an increase of the concentration of the feed mixture at or in the vicinity of the membrane surface. In case the inorganic compound is saturated in the feed mixture, it is sufficient to dilute the feed mixture with an amount of water, which is at least equal to the amount of water that is removed by the membrane from the feed mixture. When the feed mixture is not fully saturated with the inorganic compounds, part of the water can be removed until the feed mixture becomes saturated with the inorganic compounds, before it is necessary to add water for preventing scaling. When the feed mixture is supersaturated or non-dissolved with the inorganic compounds, extra water is required to reduce the dissolved solute concentration to the saturation concentration, thereby preventing formation of solids and/or dissolving the solids which were already present in the mixture.

Ultra- and nanofiltration membranes according to the invention can be both polymeric and/or ceramic membranes and are able to separate compounds on their size and electrical charge. In general these membranes are characterized by their MWCO (molecular weight cut-off) and/or retention values for inorganic salts and/or small organic molecules. The UF and NF membranes according to this invention have a MWCO smaller than 200,000 Dalton and have a maximum retention value for inorganic salts and small organic molecules of 99% (measured at 1000 ppm, 25° C. and 10 bar).

### COMPARISON EXAMPLE 1

An experiment was performed using a polypiperazine NF membrane ex Dow Chemicals (2.5″ spiral wound element, 2.6 m²). The membrane was tested in a batch-wise operated bench-scale unit using an aqueous solution comprising 2.2 g/l of FE-EDTA, 2.0 g/l of calcium, 0.9 g/l of sodium, 3.8 g/l of chloride, and 0.6 g/l of sulfate ions. The experiment was performed at pH 6.5, 46° C., 5 bar, and a concentration factor of 1.06. EDTA and chloride could be separated very well. Measured retention values for EDTA and chloride were respectively 99.4% and 20%. However, already at this low concentration factor severe scaling took place. During 16 hours of operation the permeability of the membrane decreased with more than 90%.

### EXAMPLE 2

An experiment has been performed using a polypiperazine NF membrane ex Dow Chemicals (2.5″ spiral wound element, 2.6 m²). The membrane was tested in a batch-wise operated bench-scale unit using an aqueous solution comprising. 1.1 g/l Fe-EDTA, 1.4 g/l of calcium, 1.1 g/l of sodium, 3.3 g/1 of chloride and 0.7 g/l of sulfate ions. This solution composition was obtained after addition of 1 kg water per 1 kg saturated feed solution. The experiment was performed at pH 6.5, 48° C., 6 bar, and a concentration factor of 2. EDTA and chloride could be separated very well. Measured retention values for EDTA and chloride were respectively >99.9% and 16%. During 16 hours of operation no significant scaling took place. The permeability decrease was not more than 10%.

1. A method for preventing scaling of ultrafiltration or nanofiltration membranes in a one-step membrane process of separating an organic compound or a biomass and a soluble inorganic salt from an aqueous feed mixture, which mixture further comprises one or more inorganic compounds, that cause scaling, by using an ultrafiltration or nanofiltration membrane, characterized in that the feed mixture is diluted with an amount of water which is at least equal to the amount of water that is removed by the membrane from the feed mixture minus the amount of water that can be removed without precipitation of the inorganic compounds in the feed mixture.

2. The method according to claim 1 wherein the inorganic compound are non-dissolved, supersaturated or saturated.

3. The method according to claim 1 wherein the feed mixture comprises at least one of calcium carbonate, calcium sulfate, calcium sulfite, magnesium sulfate, calcium oxalate and silica.

4. The method according to claim 1 wherein the feed mixture comprises at least one of calcium sulfate and calcium sulfite.

5. The method according to claim 1 wherein the feed mixture is saturated with the inorganic compound, and the feed mixture is diluted with an amount of water which is at least equal to the amount of water that is removed by the membrane from the feed mixture.

6. The method according to claim 1 wherein the soluble inorganic salt is a salt of a monovalent inorganic anion and a mono- or polyvalent cation.

7. The method according to claim 6 wherein the monovalent inorganic anion is chloride.

8. The method according to claim wherein the mono- or polyvalent cation is sodium, potassium, magnesium, or calcium ion.

9. The method according to claim 1 wherein the organic compound is a chelating agent, preferably an amino polycarboxylic acid or a metal complex thereof.

10. The method according to claim 9 wherein the amino polycarboxylic acid is EDTA or a metal complex thereof.

11. The method according to claim 1 for use in a nanofiltration membrane.
